(19) United States
(12) Patent Application Publication
(10) Pub. No.: US 2018/0153147 A1
(43) Pub. Date: Jun. 7, 2018

(54) FISHING LURE

(71) Applicant: Perfect Outdoor Products, LLC, Sterling Heights, MI (US)

(72) Inventor: EDWARD LAABS, STERLING HEIGHTS, MI (US)

(73) Assignee: Perfect Outdoor Products, LLC, Sterling Heights, MI (US)

(21) Appl. No.: 15/826,191

(22) Filed: Nov. 29, 2017

Related U.S. Application Data
(60) Provisional application No. 62/429,520, filed on Dec. 2, 2016.

(51) Int. Cl. A01K 85/00

(52) U.S. Cl. CPC A01K 85/00

(57) ABSTRACT

Fishing lures include a paddle-shaped plane member affixed to, or formed or carved on, a top or body surface thereof. The plane member permits the fishing lure to mimic the natural swimming patterns of vertically fleeing/escaping prey fish targeted by predatory fishes. The plane member includes first and second side surfaces, and top and bottom surfaces. An end portion may include a rounded profile. The fishing lure is operable to perform a cast into a body of water where it is allowed to sink to a desired depth. Then, upon retrieval or rod sweep, swim upwardly and then allowed to sink again. This process may be repeated until a predator fish strikes at the lure. An angle between the lure body and a bottom surface of the plane member may be in the range of 10-90 degrees relative to a horizontal plane extending lengthwise through the lure body.

### CROSS-REFERENCE TO RELATED APPLICATION

The instant application claims priority to U.S. Provisional Patent Application Ser. No. 62/429,520, filed Dec. 2, 2016, the entire specification of which is expressly incorporated herein by reference.

### FIELD OF THE INVENTION

The present invention generally relates to fishing lures, and more specifically, to new and improved fishing lures that mimic the natural swimming and fleeing/escaping patterns of prey fish generally targeted by predatory fishes.

### BACKGROUND OF THE INVENTION

A fishing lure is a type of artificial fishing bait which is designed to attract a fishes attention. The lure uses movement, vibration, flash and/or color to bait fish. Many lures are equipped with one or more hooks that are used to catch the fish when they strike at the lure. Most lures are attached to the end of a fishing line and have various styles of hooks attached to the body and are designed to elicit a strike resulting in a hookset. Modern commercial usually are often used with a fishing rod and fishing reel. When a lure is used for casting, it is generally continually cast out and retrieved, the retrieval making the lure “swim” and/or produce a bait fish's action.

Predatory fish are generally defined as fish that prey upon other fish or animals. Some predatory fish include, without limitation, bass, trout, muskellunge (“muskie”), pike, and walleye. Accordingly, fishing lure manufacturers have been interested in developing fishing lures that will attract the attention of these predatory fish for those fisherman that seek to bait and hook these predatory fish.

Referring to FIGS. 1-2, there is shown a conventional fishing lure 10, in accordance with the prior art. The fishing lure 10 includes a body 12 with a head portion 14, a middle portion 15 and a tail portion 16. The body 10 generally includes a “fish-shaped” silhouette so as to be easily recognized by the predatory fish as a potential target fish.

The head portion 14 may include a ring member 18, for example, for attachment of a fishing line 20 thereto, for example, typically near a “nose” portion 22 of the head portion 14.

The body 12 may include one or more weight members (for example, lead weights and/or the like) 24, 26, 28, respectively, for example, incorporated therein (either internal or external to the body 12) to cause the fishing lure 10 to sink within a body of water 30 when cast therein. Although three weight members are shown, it should be appreciated that either less than or more than this number of weight members may be used. Furthermore, although the weight members are shown as being inside the body 12, it should be appreciated that the weight members may be employed on the exterior (as opposed to the interior) of the body 12. The body 12 may include one or more ring members 32, 34, 36, respectively, for example, for receiving one or more hook members 38, 40, 42, respectively, to hook the fish. Although three ring members are shown, it should be appreciated that either less than or more than this number of ring members may be used. Although three hook members are shown, it should be appreciated that either less than or more than this number of hook members may be used. Furthermore, although two ring members and their corresponding hook members are shown on the “belly” portion 44 of the fishing lure 10, it should be appreciated that the placement of these ring members and their corresponding hook members may be varied. Additionally, although one ring member and its corresponding hook member is shown on the tail portion 16 of the fishing lure 10, it should be appreciated that the placement of this ring member and its corresponding hook member may be varied.

Of particular note in this fishing lure 10, is the use of a paddle-shaped plane member 46 affixed to, or formed or carved on, a bottom surface 48 of the head portion 14. Presumably, this plane member 46 was intended to allow the fishing lure 10 to mimic the natural swimming patterns of fish generally targeted by predatory fishes. However, when the attached fishing line 20 is jerked and/or retrieved by the fisherman, for example, in an upwardly direction, to make the fishing lure 10 “swim,” the fishing lure 10 instead tends to sharply swim downwardly nose first, towards a bottom surface 50 of the body of water 30, as specifically depicted in FIG. 2. It is generally believed that this particular pattern of movement of the fishing lure 10 is not thought to be that attractive to the predatory fish that fishermen seek to bait and hook.

Accordingly, there exists a need for new and improved fishing lures that overcome at least one of the aforementioned deficiencies.

### SUMMARY OF THE INVENTION

In accordance with the general teachings of the present invention, new and improved fishing lures are provided that will mimic the natural swimming patterns of prey fish generally targeted by predatory fishes.

In accordance with one embodiment of the present invention, new and improved fishing lures are described that include a paddle-shaped plane member affixed to, or formed or carved on, a top surface of a head or body portion thereof. The plane member is intended to permit the fishing lure to mimic the natural vertical fleeing/escaping swimming patterns of prey fish generally targeted by predatory fishes. The plane member includes first and second side surfaces, and top and bottom surfaces. An end portion includes a rounded or straight profile. The fishing lure is operable to perform a downward sink then upward, serpentine or sinusoidal pattern of movement as it travels through a body of water, for example, when an attached fishing line is appropriately manipulated by a fisherman, for example, by jerking an associated fishing rod upwardly. The angle between the top surface of the head portion and the bottom surface of the plane member may be in the range of 10 degrees to 90 degrees from the horizontal plane of the lure body.

In accordance with another embodiment of the present invention, a fishing lure is provided, comprising:

a body member having a head portion and a spaced and opposed tail portion; and

a paddle-shaped plane member extending angularly upwardly away from a top surface of the head portion.

In accordance with an aspect of this embodiment, the head portion tapers to a first end portion.

In accordance with an aspect of this embodiment, the tail portion tapers to a second end portion.

In accordance with an aspect of this embodiment, at least one hook member is fastened to a bottom surface of the body member.

In accordance with an aspect of this embodiment, at least one hook member is fastened to the second end portion.

In accordance with an aspect of this embodiment, at least one weight member is disposed within or on the body member.

In accordance with an aspect of this embodiment, the at least one weight member is positioned so as to maintain the body member, when submerged in a body of water, in an orientation wherein the plane member is extending angularly upwardly away from the top surface of the head portion.

In accordance with an aspect of this embodiment, at least one ring member is fastened to the first end portion, wherein the at least one ring member is operable to engage a fishing line.

In accordance with an aspect of this embodiment, the plane member is orientated at an angle in a range of 10 degrees to 90 degrees relative to a horizontal plane of the body member.

In accordance with still another embodiment of the present invention, a fishing system is provided, comprising:

a rod member;

a reel system operably associated with the rod member;

a fishing line operably associated with the reel system; and

a fishing lure, comprising:

a body member having a head portion and a spaced and opposed tail portion; and

a paddle-shaped plane member extending angularly upwardly away from a top surface of the head portion;

wherein the fishing line is fastened to the fishing lure.

In accordance with an aspect of this embodiment the head portion tapers to a first end portion and the tail portion tapers to a second end portion.

In accordance with an aspect of this embodiment at least one hook member is fastened to a bottom surface of the body member.

In accordance with an aspect of this embodiment at least one hook member is fastened to the second end portion.

In accordance with an aspect of this embodiment at least one weight member is disposed within or on the body member.

In accordance with an aspect of this embodiment the at least one weight member is positioned so as to maintain the body member, when submerged in a body of water, in an orientation wherein the plane member is extending angularly upwardly away from the top surface of the head portion.

In accordance with an aspect of this embodiment at least one ring member is fastened to the first end portion, wherein the at least one ring member is operable to engage a fishing line.

In accordance with an aspect of this embodiment, the plane member is orientated at an angle in a range of 10 degrees to 90 degrees relative to a horizontal plane of the body member.

In accordance with an aspect of this embodiment, when the fishing lure is cast into a body of water, the fishing lure sinks horizontally or head first downwardly towards a bottom surface of the body of water.

In accordance with an aspect of this embodiment, when the fishing line is at least partially retrieved, the fishing lure rises upwardly head first, away from the bottom surface of the body of water.

In accordance with an aspect of this embodiment, the fishing lure is allowed to sink horizontally or head first downwardly back towards the bottom surface of the body of water.

Further areas of applicability of the present invention will become apparent from the detailed description provided hereinafter. It should be understood that the detailed description and specific examples, while indicating the preferred embodiment of the present invention, are intended for purposes of illustration only and are not intended to limit the scope of the present invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective schematic view of a conventional fishing lure, in accordance with the prior art;

FIG. 2 is schematic view of an intended use of the fishing lure depicted in FIG. 1 demonstrating its movement in a body of water, in accordance with the prior art;

FIG. 3 is a perspective schematic view of a fishing lure, in accordance with a first embodiment of the present invention;

FIG. 4 is an elevational perspective schematic view of the fishing lure depicted in FIG. 3, in accordance with a second embodiment of the present invention;

FIG. 5 is a schematic view of a fishing rod system employing the fishing lure depicted in FIG. 3, wherein the fishing lure is deployed in a body of water, in accordance with a third embodiment of the present invention;

FIG. 6A is a schematic view of the fishing lure depicted in FIG. 3 being initially deployed in a body of water and sinking horizontally downwardly (or nose/head downwardly) towards a bottom surface of the body of water, in accordance with a fourth embodiment of the present invention;

FIG. 6B is a schematic view of the fishing lure depicted in FIG. 3 being jerked or retrieved head first in the body of water, in accordance with a fifth embodiment of the present invention;

FIG. 6C is a schematic view of the fishing lure depicted in FIG. 3 sinking head first back towards the bottom surface of the body of water, in accordance with a sixth embodiment of the present invention;

FIG. 6D is a schematic view of the fishing lure depicted in FIG. 3 alternatively sinking horizontally towards the bottom surface of the body of water, in accordance with a seventh embodiment of the present invention;

FIG. 6E is a schematic view of the fishing lure depicted in FIG. 3 again being jerked or retrieved head first in the body of water, in accordance with an eighth embodiment of the present invention; and

FIG. 6F is a schematic time lapse view of the pattern of the movements of the fishing lure depicted in FIGS. 6A-6E, in accordance with a ninth embodiment of the present invention;

The same reference numerals refer to the same parts throughout the various Figures.

### DETAILED DESCRIPTION OF THE INVENTION

The following description of the preferred embodiment(s) is merely exemplary in nature and is in no way intended to limit the present invention, or uses.

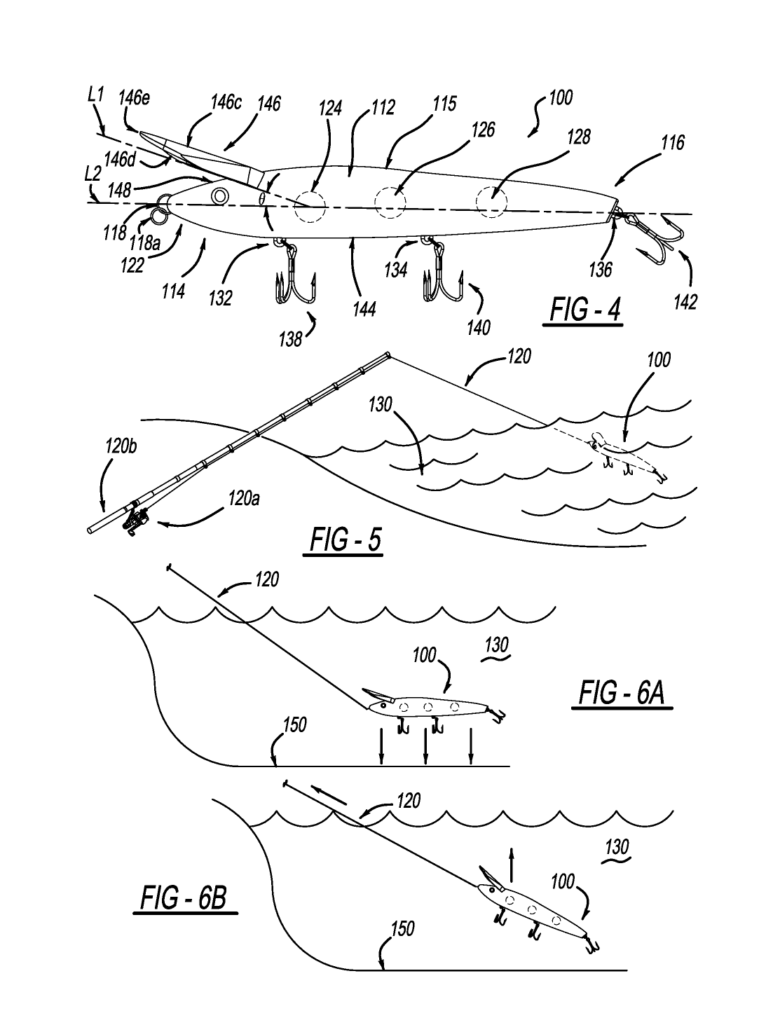

Referring to FIGS. 3-6F, there is a new and improved fishing lure generally shown at 100.

The fishing lure 100 includes a body 112 with a head portion 114, a middle portion 115 and a tail portion 116. The body 100 generally includes a “fish-shaped” silhouette so as to be easily recognized by the predatory fish as a potential target fish.

The head portion 114 may include a nose loop member 118, for example, for attachment of a fishing line 120 thereto, for example, typically near a “nose” portion 122 of the head portion 114. It should be appreciated that a line attachment split ring 118a can be attached to the nose loop member 118. In this manner, the fishing line 120 would be connected to the line attachment split ring 118a. It should also be appreciated that the fishing line 120 would typically be contained in a reel 120a, which in turn would typically be mounted to a fishing rod 120b, for example, as specifically shown in FIG. 5.

The body 112 may include one or more weight members (for example, lead weights and/or the like) 124, 126, 128, respectively, for example, incorporated therein to cause the fishing lure 10 to sink within a body of water 130 when cast therein. Although three weight members are shown, it should be appreciated that either less than or more than this number of weight members may be used. Furthermore, although the weight members are shown as being inside the body 112, it should be appreciated that the weight members may be employed on the exterior (as opposed to the interior) of the body 112.

The body 112 may include one or more fixed hook hangar loops 132, 134, 136, respectively, for example, for receiving one or more hook members 138, 140, 142, respectively, (e.g., via split rings) to hook the fish. Although three ring members are shown, it should be appreciated that either less than or more than this number of ring members may be used. Although three hook members are shown, it should be appreciated that either less than or more than this number of hook members may be used. Furthermore, although two ring members and their corresponding hook members are shown on the “belly” portion 144 of the fishing lure 100, it should be appreciated that the placement of these ring members and their corresponding hook members may be varied. Additionally, although one ring member and its corresponding hook member is shown on the tail portion 116 of the fishing lure 100, it should be appreciated that the placement of this ring member and its corresponding hook member may be varied.

Of particular note in this fishing lure 100, is the use of a paddle-shaped plane member 146 affixed to, or formed or carved on, a top surface 148 of the head portion 114. This plane member 146 is intended to allow the fishing lure 100 to mimic the natural swimming or fleeing/escaping patterns of fish generally targeted by predatory fishes. The plane member 146 include first and second side surface 146a, 146b, respectively, and top and bottom surfaces 146c, 146d, respectively. An end portion 146e includes a rounded or flat profile.

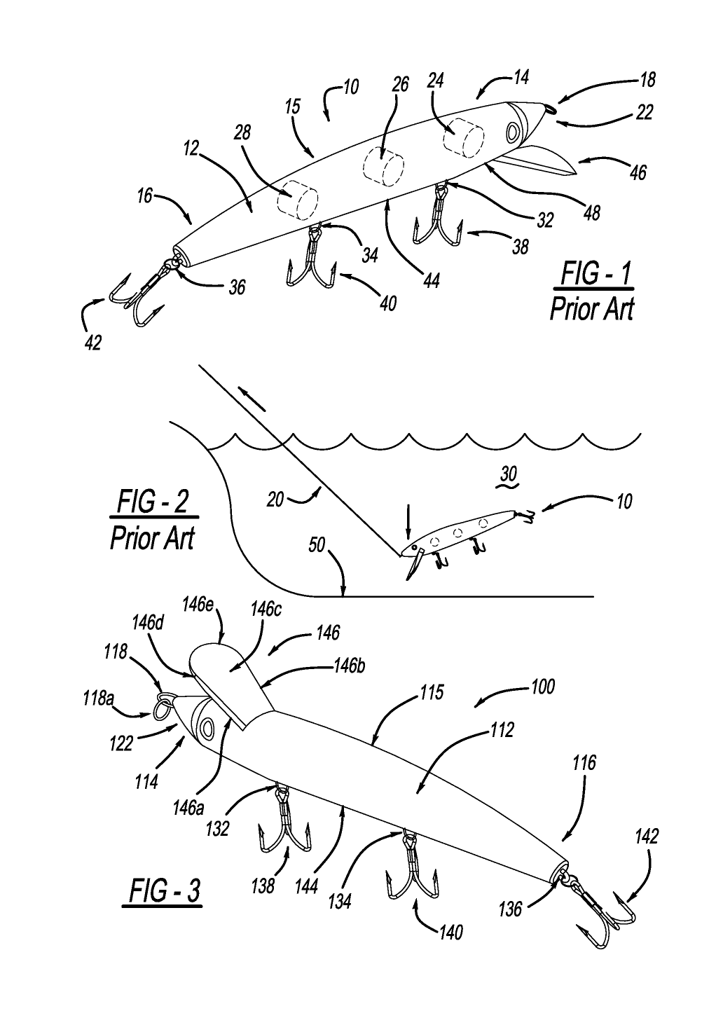

Without being bound to a particular theory of the operation of the present invention, the number of weight members and/or their placement is intended to cause the body 112 to achieve and/or maintain an “upright” or generally upright position when the fishing lure is cast into a body of water. By “upright” position, as that term is used herein, it is meant to include any position that primarily ensures that the plane member 146 is oriented upwardly toward the surface of the body of water (e.g., as depicted in FIGS. 3-6F), as opposed to downwardly toward the bottom of the body of water. That is, the number of weight members and/or their placement is intended to keep the body 112 from “rolling over” once it is placed into the body of water and assuming an orientation similar to that depicted in FIGS. 1-2. By way of a non-limiting example, the weight members may be placed near or proximate to the coronal (or horizontal) plane (i.e., the midline) extending from the “nose” portion 122 to the tail portion 116 of the body 112 and/or the “belly” portion 144. It should be appreciated that the body 112 may slightly “wiggle” from side to side when in the body of water, yet still maintain an “upright” or generally upright position when in the body of water.

Again, without being bound to a particular theory of the operation of the present invention, the number of hook members and/or their placement is also intended to cause the body 112 to achieve and/or maintain an “upright” or generally upright position when the fishing lure is cast into a body of water. As noted above, by “upright” position, as that term is used herein, it is meant to include any position that primarily ensures that the plane member 146 is oriented upwardly toward the surface of the body of water (e.g., as depicted in FIGS. 3-6F), as opposed to downwardly toward the bottom of the body of water. That is, the number of hook members and/or their placement is intended to keep the body 112 from “rolling over” once it is placed into the body of water and assuming an orientation similar to that depicted in FIGS. 1-2. By way of a non-limiting example, the hook members may be placed near or proximate to the “belly” portion 144 and/or the tail portion 116. Again, it should be appreciated that the body 112 may slightly “wiggle” from side to side when in the body of water, yet still maintain an “upright” or generally upright position when in the body of water.

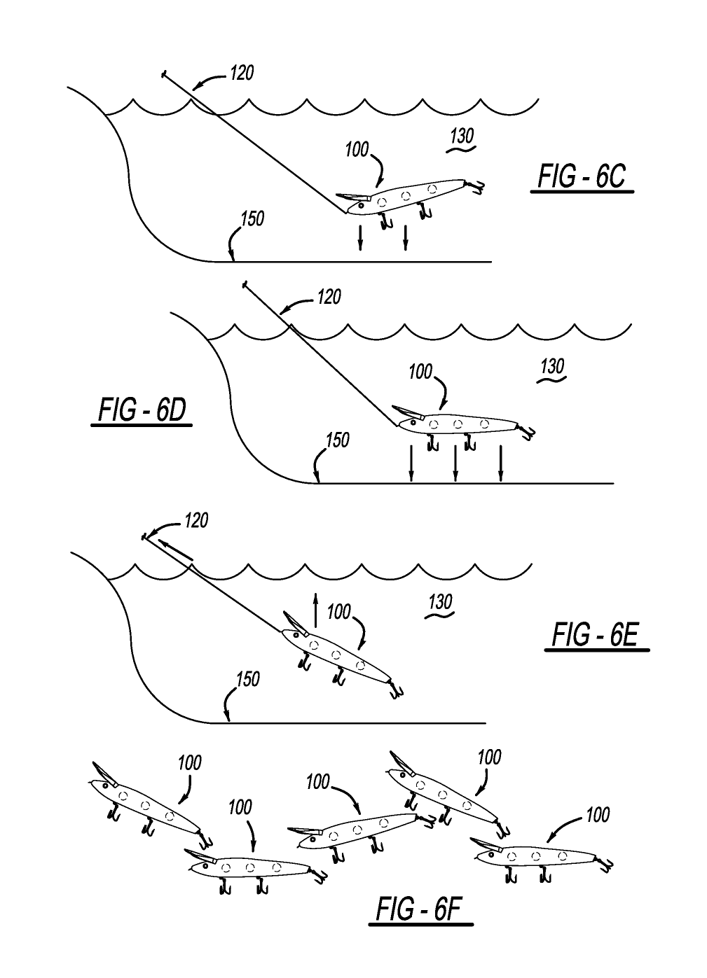

For example, when the attached fishing line 120 is first cast into the body of water 130, the fishing lure 100 will sink horizontally or nose/head first downwardly towards a bottom surface 150 of the body of water 130, for example, as specifically depicted in FIG. 6A. The sink rate of the fishing lure 100 is preferably in the range of about 0.5 to 1 foot per second.

When the fishing line 120 is jerked or retrieved by the fisherman to make the fishing lure 100 “swim,” the fishing lure 100 will rise upwardly nose/head first, away from the bottom surface 150 of the body of water 130, for example, as specifically depicted in FIG. 6B.

The fishing lure 100 is then allowed to sink horizontally or nose/head first back towards the bottom surface 150 of the body of water 130, for example, as specifically depicted in FIG. 6C.

Alternatively, the fishing lure 100 may sink horizontally or nose/head first downwardly towards the bottom surface 150 of the body of water 130, for example, as specifically depicted in FIG. 6D.

When the fishing line 120 is then again jerked or retrieved by the fisherman, it will make the fishing lure 100 “swim” again, causing the fishing lure 100 to rise upwardly nose/head first, away from the bottom surface 150 of the body of water 130, for example, as specifically depicted in FIG. 6E.

Referring to FIG. 6F, there is shown a schematic “time lapse” view of the pattern of the movements of the fishing lure 100 depicted in FIGS. 6A-6E to show this down and then upward, serpentine or sinusoidal pattern of movement of the fishing lure 100 as it travels through the body of water 130, for example, when the fishing line 120 is appropriately manipulated by the fisherman, as described above. This particular pattern of movement of the fishing lure 100 through the body of water 130 is believed to be very attractive to the predatory fish that fishermen seek to bait and hook, as it mimics the natural fleeing or injured swimming patterns of prey fish generally targeted by predatory fishes.

The exact angle between the plane member 146 relative to the head portion 114 of the body 112 is not thought to be critical to the practice of the present invention, provided that the movement of the fishing lure 100 can achieve the upward movements depicted in FIGS. 6B and 6E when the fishing line 120 is manipulated by the fisherman, for example, in an upwardly or sideways direction. By way of a non-limiting example, the angle θ between the head portion 114 of the body 112 and the bottom surface 146c of the plane member 146 is preferably equal to or greater than 10 degrees, equal to or less than 90 degrees, and in the range of 10 degrees to 90 degrees (or any degree therebetween) from the horizontal plane (e.g., extending lengthwise) of the lure body. By way of a non-limiting example, the angle θ is intended to be formed by an intersection (e.g., at a vertex) of a line L1 extending along the bottom surface 146c of the plane member 146 towards the body 112 (e.g., in proximity to the head portion 114) and a generally horizontal line L2 extending through the coronal (or horizontal) plane of the body 112, wherein the line L2 preferably bisects the center of both the nose loop member 118 and the fixed hook hangar loop 136. It should be appreciated that the position of the vertex formed by the intersection of lines L1, L2, respectively, may change if the plane member 146 is either lowered (e.g., towards the top surface 148 of the head portion 114), which would decrease the angle θ or raised (e.g., away from the top surface 148 of the head portion 114), which would increase the angle θ. By way of a non-limiting example, the determination of the angle θ is preferably accomplished when the fishing lure 100 is on an even keel, i.e., it is not tipped either left/right and/or inboard/outboard.

While the present invention has been described with reference to an exemplary embodiment, it will be understood by those skilled in the art that various changes can be made and equivalents can be substituted for elements thereof without departing from the scope of the present invention. In addition, many modifications can be made to adapt a particular situation or material to the teachings of the present invention without departing from the essential scope thereof. Therefore, it is intended that the present invention not be limited to the particular embodiment disclosed as the best mode contemplated for carrying out this present invention, but that the present invention will include all embodiments falling within the scope of the appended claims.

What is claimed is:

1. A fishing lure, comprising:
a body member having a head portion and a spaced and opposed tail portion; and
a paddle-shaped plane member extending angularly upwardly away from a top surface of the head portion.

2. The fishing lure according to claim 1, wherein the head portion tapers to a first end portion.

3. The fishing lure according to claim 1, wherein the tail portion tapers to a second end portion.

4. The fishing lure according to claim 1, further comprising at least one hook member fastened to a bottom surface of the body member.

5. The fishing lure according to claim 3, further comprising at least one hook member fastened to the second end portion.

6. The fishing lure according to claim 1, further comprising at least one weight member disposed within or on the body member.

7. The fishing lure according to claim 6, wherein the at least one weight member is positioned so as to maintain the body member, when submerged in a body of water, in an orientation wherein the plane member is extending angularly upwardly away from the top surface of the head portion.

8. The fishing lure according to claim 2, further comprising at least one ring member fastened to the first end portion, wherein the at least one ring member is operable to engage a fishing line.

9. The fishing lure according to claim 1, wherein the plane member is orientated at an angle in a range of 10 degrees to 90 degrees relative to a horizontal plane of the body member.

10. A fishing system, comprising:
a rod member;
a reel system operably associated with the rod member;
a fishing line operably associated with the reel system; and
a fishing lure, comprising:
a body member having a head portion and a spaced and opposed tail portion; and
a paddle-shaped plane member extending angularly upwardly away from a top surface of the head portion;
wherein the fishing line is fastened to the fishing lure.

11. The fishing system according to claim 10, wherein the head portion tapers to a first end portion and the tail portion tapers to a second end portion.

12. The fishing system according to claim 10, further comprising at least one hook member fastened to a bottom surface of the body member.

13. The fishing system according to claim 11, further comprising at least one hook member fastened to the second end portion.

14. The fishing system according to claim 10, further comprising at least one weight member disposed within or on the body member.

15. The fishing system according to claim 14, wherein the at least one weight member is positioned so as to maintain the body member, when submerged in a body of water, in an orientation wherein the plane member is extending angularly upwardly away from the top surface of the head portion.

16. The fishing system according to claim 11, further comprising at least one ring member fastened to the first end portion, wherein the at least one ring member is operable to engage a fishing line.

17. The fishing system according to claim 10, wherein the plane member is orientated at an angle in a range of 10 degrees to 90 degrees relative to a horizontal plane of the body member.

18. The fishing system according to claim 10, wherein when the fishing lure is cast into a body of water, the fishing lure sinks horizontally or head first downwardly towards a bottom surface of the body of water.

19. The fishing system according to claim 18, wherein when the fishing line is at least partially retrieved, the fishing lure rises upwardly head first, away from the bottom surface of the body of water.

20. The fishing system according to claim 19, wherein the fishing lure is allowed to sink horizontally or head first downwardly back towards the bottom surface of the body of water.
